(19) United States
(12) Patent Application Publication
(10) Pub. No.: US 2007/0094681 A1
(43) Pub. Date: Apr. 26, 2007

(54) Displaying apparatus and channel information displaying method thereof

(75) Inventor: Bong-hwan Park, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/542,119

(22) Filed: Oct. 4, 2006

(30) Foreign Application Priority Data
Oct. 10, 2005 (KR) 10-2005-0095145

(51) Int. Cl. H04N 5/445

(52) U.S. Cl. 725/37

(57) ABSTRACT

A display apparatus and a channel information displaying method thereof are provided. The channel information displaying method of a display apparatus having a channel storage unit for storing channel identification information and channel receipt information about a plurality of channels includes: determining whether a new channel is received in addition to the plurality of channels, based on the channel identification information and the channel receipt information stored in the channel storage unit; storing the channel identification information and the channel receipt information about the new channel in the channel storage unit when the new channel is received; and displaying an indication indicating that the new channel is added and the channel identification information. With this configruation, a user may recognize whether a channel is added and which channel is added.

This application claims priority from Korean Patent Application No. 10-2005-0095145, filed on Oct. 10, 2005, in the Korean Intellectual Property Office, the disclosure of which is incorporated herein by reference.

### BACKGROUND OF THE INVENTION

1. Field of the Invention

Apparatuses and methods consistent with the present invention relate to displaying channel information.

2. Description of the Related Art

A display apparatus such as a television (TV) receives a broadcasting signal from ground wave broadcasting, digital TV broadcasting, cable TV broadcasting, etc., and processes the received broadcasting signal, thereby outputting an image and sound. As broadcasting techniques are developed, broadcasting channels are also increased in variety. Thus, it frequently occurs that a channel is changed or added.

However, most users watch the TV through the initial channel setup without scanning and updating the channels occasionally. Therefore, it is difficult to determine whether a channel is changed or added. Accordingly, it is problematic to watch a changed or newly-added channel.

Thus, there exists a need for periodically monitoring channels added by a broadcasting station, storing channel information if there is an added channel, and displaying a channel list, channel information, or an electronic program guide (EPG) containing the added channel if a user instructs the display apparatus to display the channel list, channel information, or an EPG.

Further, if the channel information is updated automatically, it is difficult and inconvenient for the user to recognize whether a channel is added and, if so, which channel is added.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a display apparatus which allows a user to recognize whether a channel is added, and if so, which channel is added, and a channel information displaying method thereof.

According to an aspect of the present invention, there is provided a channel information displaying method of a display apparatus having a channel storage unit for storing channel identification information and channel receipt information related to a plurality of channels, the method comprising: determining whether a new channel is received in addition to the plurality of channels, based on the channel identification information and the channel receipt information stored in the channel storage unit; storing channel identification information and channel receipt information related to the new channel in the channel storage unit if the new channel is received; and displaying an indication indicating that the new channel is added and the channel identification information related to the new channel.

According to an aspect of the invention, the channel information displaying method further comprises removing the indication if the indication is displayed a number of times.

According to an aspect of the invention, the channel information displaying method further comprises removing the indication if the indication is displayed over a period of time.

According to an aspect of the invention, the indication comprises a letter.

According to an aspect of the invention, the indication comprises at least one of a symbol and an image.

According to another aspect of the present invention, there is provided a channel information displaying method of a display apparatus having a display unit and a channel storage unit which stores channel identification information and channel receipt information related to a plurality of channels, the method comprising: determining whether a new channel is received in addition to the plurality of channels, based on the channel identification information and the channel receipt information stored in the channel storage unit; storing channel identification information and channel receipt information related to the new channel in the channel storage unit if the new channel is received; and displaying notification information indicating that the new channel is added along with an image on the display unit if the image corresponds to the new channel.

According to an aspect of the invention, the channel information displaying method further comprises removing the indication of the notification information if the notification information is displayed a number of times.

According to an aspect of the invention, the channel information displaying method further comprises removing the indication of the notification information if the notification information is displayed over a period of time.

According to an aspect of the invention, the notification information comprises a letter.

According to an aspect of the invention, the notification information comprises at least one of a symbol and an image.

Still another aspect of the present invention provides a display apparatus comprising a display unit, a tuner which receives a broadcasting signal, and a signal processor which processes the received broadcasting signal, the display apparatus comprising: a channel storage unit which stores channel identification information and channel receipt information related to a plurality of channels; a user interface (UI) generator which generates a list corresponding to the channel identification information; and a controller which controls the channel storage unit to store channel identification information and channel receipt information related to a new channel and controls the UI generator to generate the list indicating that the new channel is added if the new channel is received in addition to the plurality of channels, based on the channel identification information and channel receipt information related to the new channel stored in the channel storage unit.

According to an aspect of the invention, the controller controls the UI generator to remove an indication that the new channel is added if the indication is displayed a number of times.

According to an aspect of the invention, the controller controls the UI generator to remove an indication that the new channel is added if the indication is displayed over a period of time.

According to an aspect of the invention, the indication comprises letters.

According to an aspect of the invention, the indication comprises symbols.

According to yet another aspect of the present invention, there is provided a display apparatus comprising a display unit, a tuner which receives a broadcasting signal, and a signal processor which processes the received broadcasting signal, the display apparatus comprising: a channel storage unit which stores channel identification information and channel receipt information related to a plurality of channels; a UI generator which generates notification information informing a user that a new channel is added; and a controller which controls the channel storage unit to store channel identification information and channel receipt information related to the new channel if the new channel is received in addition to the plurality of channels, based on the channel identification information and the channel receipt information stored in the channel storage unit, and controls the UI generator to generate the notification information if an image corresponding to the new channel is displayed on the display unit.

According to an aspect of the invention, the controller controls the UI generator to remove the notification information if the notification information is displayed a number of times.

According to an aspect of the invention, the controller controls the UI generator to remove the notification information if the notification information is displayed over a period of time.

According to an aspect of the invention, the indication comprises letters.

According to an aspect of the invention, the indication comprises symbols.

### BRIEF DESCRIPTION OF THE DRAWINGS

The above and other aspects of the prevent invention will become apparent and more readily appreciated from the following description of the exemplary embodiments, taken in conjunction with the accompany drawings, in which:

FIG. 1 is a block diagram of a display apparatus according to an exemplary embodiment of the present invention.

FIGS. 2A and 2B are views illustrating a channel list window and a channel information window according to an exemplary embodiment of the present invention.

FIG. 3 is a flowchart illustrating an operation of a display apparatus according to an exemplary embodiment of the present invention.

### DETAILED DESCRIPTION OF EXEMPLARY EMBODIMENTS OF THE INVENTION

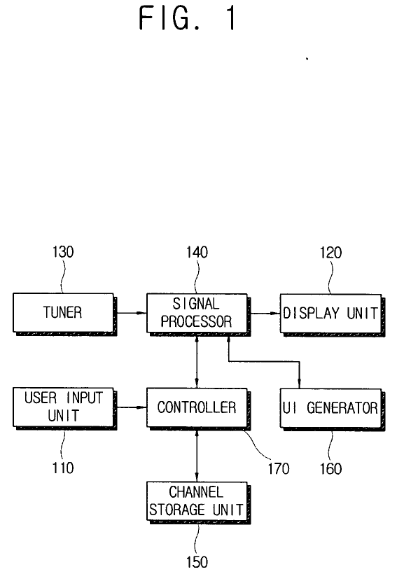

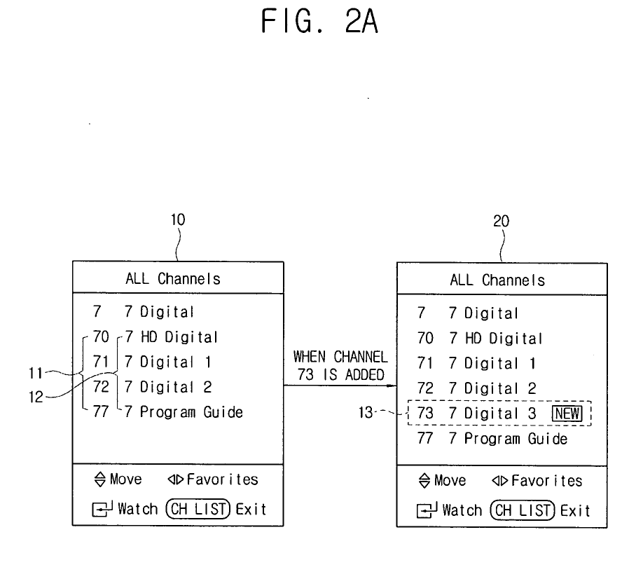

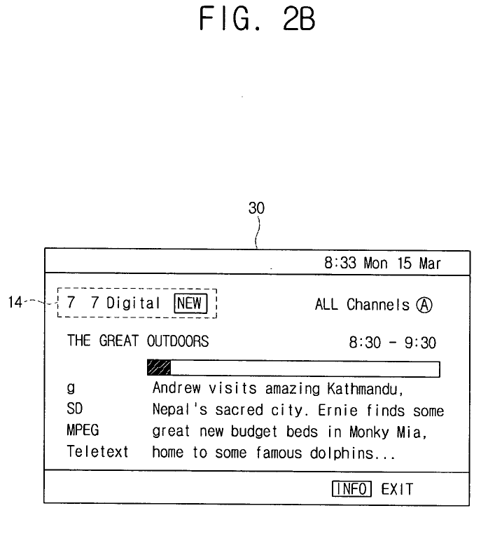

Hereafter, exemplary embodiments of the present invention will be described in a more detailed manner with reference to the accompanying drawings. FIG. 1 is a block diagram of a display apparatus 100 according to an exemplary embodiment of the present invention, and FIGS. 2A and 2B are views illustrating a channel list window and a channel information window according to an exemplary embodiment of the present invention. An exemplary embodiment of the present invention will be described in more detail with reference to FIGS. 1, 2A and 2B.

A display apparatus 100 according to an exemplary embodiment of the present invention receives and processes a broadcasting signal from a broadcasting station to display it on a display unit 120. The display apparatus 100 according to the exemplary embodiment includes a user input unit 110, a display unit 120, a tuner 130, a signal processor 140, a channel storage unit 150, a user interface (UI) generator 160 and a controller 170.

The user input unit 110 receives an instruction from a user and transfers it to the controller 170. The user input unit 110 may include channel up/down keys of the display apparatus 100, numeric keys for selecting a broadcasting channel, a menu key provided in a remote controller or a casing, and a key signal generator for generating a key signal corresponding to the operation of keys. The user input unit 110 is instructed by a user through a menu key to display a channel list, channel information, or an EPG, and thus transmits the instruction to the controller 170.

The display unit 120 receives a video signal converted by the signal processor 140 and displays an image on a screen. The display unit 120 may include one of Cathode Ray Tube (CRT), Liquid Crystal Display (LCD), and Plasma Display Panel (PDP). Alternatively, the display unit 120 can be achieved by other types of displays which display images.

The tuner 130 tunes the broadcasting signal received in the display apparatus 100 to a broadcasting signal having a corresponding frequency bandwidth in accordance with the channel selected by the user. The tuner 130 applies a demodulation process and an error correction process to the tuned broadcasting signal corresponding to a specific channel, and outputs it in a transport stream format. Further, the tuner 130 splits the tuned broadcasting signal into a video signal, an audio signal and various additional data and outputs them in a bit stream format.

The signal processor 140 converts the video signal received from the controller 170 to have a proper format, for example, digital RGB signal with which the display unit 120 can display an image, and outputs it to the display unit 120. Here, the signal processor 140 includes a scaler serving to convert vertical frequency, resolution, screen ration, etc., of the video signal received from the controller 170 in order to properly format the signal for the display unit 120.

The channel storage unit 150 stores channel information such as a channel name, a channel frequency, etc. The channel name and the channel frequency of the exemplary embodiment are used as channel identification information and channel receipt information, respectively. The channel storage unit 150 can be implemented by a flash memory, an Electrically Erasable Programmable Read-Only Memory (EEPROM), an Erasable Programmable Read-Only Memory (EPROM), etc.

The UI generator 160 generates a UI signal according to control of controller 170. When the UI generator 160 is controlled by the controller 170 to display the channel list, it generates a channel list which indicates a new channel is added to the channel list. Here, the channel lists 10, 20 according to the exemplary embodiment show a channel number 11 and brief information 12 corresponding to the channel number as shown in FIG. 2A. The channel list 20 after a new channel is added thereto shows “NEW” on the right side of the added channel number 73 (refer to “13” of FIG. 2A) unlike the channel list 10 before the new channel is added.

In another exemplary embodiment shown in FIG. 2B, when the UI generator 160 is controlled by the controller 170 to display channel information about a new channel, it generates channel information 30 which indicates a new channel is added to the channel list. Here, the channel information 30 according to the exemplary embodiment shows detailed information about the channel such as a channel name, a program name of a corresponding time range, etc. If the channel information is in relation to the new channel, “NEW” is displayed on the right side of a channel name 14 of the new channel to indicate the added channel.

In another exemplary embodiment, when the UI generator 160 is controlled by the controller 170 to display an image corresponding to the new channel, it generates an icon such as “NEW” to be shown on a region, for example, on an upper right side of the display unit, which indicates the new channel is added. Here, the word “NEW” is employed as only an example, and not limited thereto. Alternatively, various words, a mark, a symbol, etc. can be used for indicating the new channel. For example, “ADDED” can be used instead of “NEW”.

The controller 170 generally controls the operation of the user input unit 110, the display unit 120, the tuner 130, the signal processor 140, the channel storage unit 150, and the UI generator 160. If the controller 170 determines that a new channel was received in addition to the stored channels on the basis of the channel name, the channel frequency, etc. stored in the channel storage unit 150, the controller 170 controls the channel storage unit 150 to store the channel name, channel frequency, etc. of the received new channel.

When the controller 170 is instructed to display the channel list according to input signals from the user input unit 110, it displays “NEW” on the next to new channel name to indicate a new channel is added to the channel list, and controls the UI generator 160 to generate a channel list which sorts and shows the new channel along with the existing channels. Alternatively, the channel list according to the exemplary embodiment may be used in various applications, for example, representing “NEW” for indicating a new channel so as to inform a user that the new channel is an added, through other means such as the channel information, the EPQ etc. In addition, if an image is displayed corresponding to the new channel, the controller 170 may control the UI generator 160 to generate an icon such as “NEW” to be displayed in a region of the display unit, thereby indicating that the new channel is added.

The controller 170 may be implemented as a software program to be adapted for a universal processor, and stored in a memory (for example, ROM) to be executed by the universal processor.

In the exemplary embodiment, it may be desirable to cause an indication, which indicates the new channel is added, not to be displayed if it is displayed over a period of time or a number of times. The period of time or the number of times may be setup through the user input unit 110.

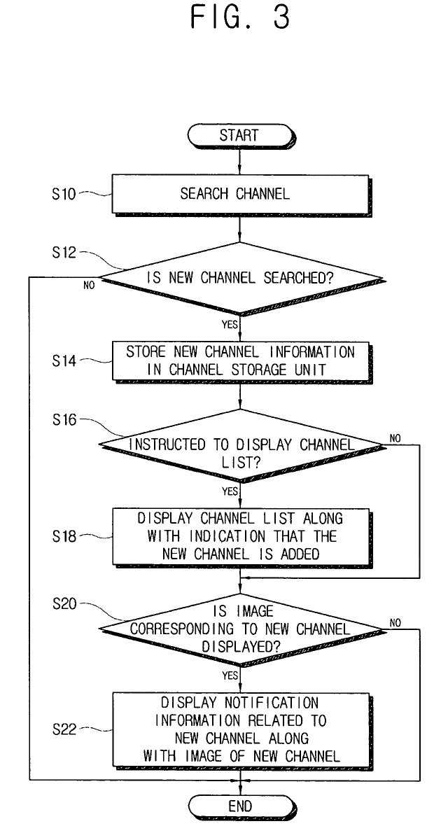

FIG. 3 is a flowchart of illustrating an operation of a display apparatus 100 according to an exemplary embodiment of the present invention. An operation of the display apparatus 100 according to an exemplary embodiment of the present invention will be described in more detail with reference to FIG. 3.

The controller 170 periodically monitors the broadcasting signal received in the display apparatus 100 and searches a channel corresponding to the broadcasting signal (S10). In the result of search, if a new channel is not searched other than the channels stored in the channel storage unit 150 (S12), the currently stored channels are kept and channel monitoring is suspended until a next searching time. On the contrary, if the new channel is searched in addition to the channels stored in the channel storage unit 150, the controller 170 controls the channel storage unit 150 to store the channel information about the new channel such as the channel name, the channel frequency and the like therein (S14).

When the controller 170 receives an input signal from the user input unit 110, which instructs the controller 170 to display the channel list (S16), the controller 170 controls the UI generator 160 to generate the channel list in which “NEW” is represented on the right side of the new channel name, and displays the generated channel list on the display unit 120 (S18). When the controller 170 is instructed to display images corresponding to the new channel (S20), it displays the images corresponding to the new channel on the display unit 120 and simultaneously displays an icon representing “NEW” on the upper right side of the display unit (S22). In this exemplary embodiment, the icon is used as notification information, which indicates the new channel is added, according to the present invention. Alternatively, the notification information may be implemented in other forms.

Thus, a user can recognize whether channel is added and which channel is added.

As mentioned above, the exemplary embodiments of the present invention provide a display apparatus and a channel information displaying method thereof, in which a user may recognize whether a channel is added and which channel is added.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A channel information displaying method of a display apparatus, the method comprising:
determining whether a new channel is received based on channel identification information and channel receipt information related to a plurality of channels stored in a channel storage unit of the display apparatus;
storing channel identification information and channel receipt information related to the new channel in the channel storage unit if it is determined that the new channel is received; and
displaying an indication indicating that the new channel is added and the channel identification information related to the new channel.

2. The channel information displaying method according to claim 1, further comprising:
terminating the displaying of the indication if the indication is displayed a certain number of times.

3. The channel information displaying method according to claim 1, further comprising:
terminating the displaying of the indication if the indication is displayed over a certain period of time.

4. The channel information displaying method according to claim 1, wherein the indication comprises a word.

5. The channel information displaying method according to claim 1, wherein the indication comprises at least one of a symbol and an image.

6. A channel information displaying method of a display apparatus, the method comprising:
determining whether a new channel is received based on channel identification information and channel receipt information related to a plurality of channels stored in a channel storage unit of the display apparatus;
storing channel identification information and channel receipt information related to the new channel in the channel storage unit if it is determined that the new channel is received; and
displaying notification information indicating that the new channel is added along with an image on a display unit of the display apparatus if the image corresponds to the new channel.

7. The channel information displaying method according to claim 6, the method further comprising:
terminating the displaying of the notification information if the notification information is displayed a certain number of times.

8. The channel information displaying method according to claim 6, the method further comprising:
terminating the displaying of the indication if the notification information is displayed over a certain period of time.

9. The channel information displaying method according to claim 6, wherein the notification information comprises a word.

10. The channel information displaying method according to claim 6, wherein the notification information comprises at least one of a symbol and an image.

11. A display apparatus comprising:
a display unit; a channel storage unit which stores channel identification information and channel receipt information related to a plurality of channels;
a user interface (UI) generator which generates a channel list displayed via the display unit; and
a controller which controls the channel storage unit to store channel identification information and channel receipt information related to a new channel and controls the UI generator to generate the channel list indicating that the new channel is added if the new channel is received in addition to the plurality of channels, based on the channel identification information and channel receipt information stored in the channel storage unit.

12. The display apparatus according to claim 11, wherein the controller controls the UI generator to remove from the channel list an indication that the new channel is added if the indication is displayed a certain number of times.

13. The display apparatus according to claim 11, wherein the controller controls the UI generator to remove from the channel list an indication that the new channel is added if the indication is displayed over a certain period of time.

14. The display apparatus according to claim 11, wherein the UI generator generates an indication comprising a word to indicate that the new channel is added, and the indication is displayed on the display unit.

15. The display apparatus according to claim 11, wherein the UI generator generates an indication comprising a symbol to indicate that the new channel is added, and the indication is displayed on the display unit.

16. A display apparatus comprising:
a display unit;
a channel storage unit which stores channel identification information and channel receipt information related to a plurality of channels;
a user interface (UI) generator which generates notification information informing a user that the new channel is added, the notification being displayed on the display unit; and
a controller which controls the channel storage unit to store channel identification information and channel receipt information related to the new channel if the new channel is received, based on the channel identification information and the channel receipt information stored in the channel storage unit, and contols the UI generator to generate the notification information if an image corresponding to the new channel is displayed on the display unit.

17. The display apparatus according to claim 16, wherein the controller controls the UI generator to terminate the display of the notification information if the notification information is displayed a certain number of times.

18. The display apparatus according to claim 16, wherein the controller controls the UI generator to terminate the display of the notification information if the notification information is displayed over a certain period of time.

19. The display apparatus according to claim 16, wherein the notification information comprises a word.

20. The display apparatus according to claim 16, wherein the notification information comprises symbols.
